(19) United States
(12) Patent Application Publication
(10) Pub. No.: US 2007/0096911 A1
(43) Pub. Date: May 3, 2007

(54) High temperature product identification system and method

(75) Inventor: Devlin M. Gualtieri, Ledgewood, NJ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/266,814

(22) Filed: Nov. 3, 2005

(51) Int. Cl. G08B 13/14; G06K 19/00

(52) U.S. Cl. 340/572.2; 340/572.8; 235/487

(57) ABSTRACT

An object identification system and method includes a mechanical resonator that is configured to vibrate at one or more resonant vibration frequencies upon being excited with an electromagnetic field. A sensor circuit supplies the electromagnetic field to excite the mechanical resonator and a sensor signal that is modulated based on the one or more resonant vibration frequencies of the mechanical resonator. The modulated sensor signal is demodulated and analyzed to determine the resonant vibration frequencies of the resonator, which uniquely identify the resonator.

### TECHNICAL FIELD

The present invention relates to product identification and, more particularly, to a remote product identification system and method that is usable in high temperature environments.

### BACKGROUND

There are many applications today where it is desired to sense the presence and location of a specific object such as, for example, a component that may be stored in a warehouse, on a pallet, in a shipping container, or installed in another device or system. For example, a warehouse attendant, shipping clerk, technician, or engineer may need to determine whether a particular component is present and where the particular component is located. Moreover, it is desired that component provenance is determinable, that component counterfeiting is prevented, and that repair and overhaul operations are documented.

Various technologies have been developed to address one or more of the above-mentioned concerns. These technologies include, for example, bar-code identification systems and radio frequency identification (RFID) systems. Bar-code identification systems can exhibit limited functionality. For example, a user must typically scan each bar code label at close range with a bar code reader. Moreover, in some instances, several components may have to be scanned before the user can be sure whether or not the desired component is or is not present. This can be extremely time consuming and inefficient.

RFID systems include RFID tags and RFID readers. An RFID tag is typically an electronic device that is configured to be attached to component and contains a unique identifier (e.g., an ID number). An RFID tag reader is used to read the unique identifier by, for example, interrogating the RFID tag with a radio frequency (RF) signal. More specifically, when an RFID tag is interrogated by an RF signal emitted by an RFID tag reader, the RFID tag emits at least its unique identifier. Thus, unlike bar-code identification systems, the RFID tag reader need not be in close physical proximity to the RFID tag to read its unique identifier. For this, and various other reasons, RFID systems have found ever increasing use in various markets.

Although RFID systems do provide various advantages over bar-code identification systems, these systems do suffer certain drawbacks. For example, most RFID tags are manufactured using silicon or similar semiconductor materials, which may not function properly at elevated temperatures. For example, most RFID tags are designed to operate at temperatures below 200° C., and most typically below 125° C. Indeed, when RFID tags are exposed to temperatures above these typical thresholds, the RFID tag functionality can be diminished or destroyed.

In addition to RFID systems, various types of mechanical vibrations systems have also been developed. The systems typically use magnetoelastic, magnetostrictive, or amorphous type materials. Although these systems are useful, these types of materials either undergo a change in a mechanical material property, such as a dimension, upon application of a magnetic field, or are unsuitable for use at relatively high temperatures, or both.

Various components that are used in aerospace and other applications are exposed, during use, to temperatures that exceed the operating temperatures of most RFID tags, and many magnetoelastic, magnetostrictive, and amporphous materials. Hence, there is a need for a system and method of providing remote object identification that is usable at the elevated temperatures to which many components are exposed during use. The present invention addresses at least this need.

### BRIEF SUMMARY

The present invention provides an object identification system and method that is usable in high temperature environments.

In one embodiment, and by way of example only, an object identification system includes a mechanical resonator and a sensor circuit. The mechanical resonator is configured to vibrate at one or more resonant vibration frequencies upon excitation thereof with an electromagnetic field. The sensor circuit includes at least a portion thereof that is disposed adjacent the mechanical resonator, and is operable to supply the electromagnetic field to excite the mechanical resonator and a sensor signal that is modulated based on the one or more resonant vibration frequencies of the mechanical resonator.

In another exemplary embodiment, an object identification system includes a mechanical resonator and a sensor circuit. The mechanical resonator has a plurality of cantilevered tines coupled to and extending from a main body. Each of the cantilevered tines is configured to vibrate, upon excitation thereof with an electromagnetic field, at a resonant vibration frequency that differs from the resonant vibration frequency of another cantilevered tine. The sensor circuit includes at least a portion thereof that is disposed adjacent to the mechanical resonator, and is operable to supply the electromagnetic field to excite each of the cantilevered tines and a sensor signal that is modulated based on the resonant vibration frequencies of each of the cantilevered tines.

In yet another exemplary embodiment, a method of generating an object identification signal includes exciting a mechanical resonator with an electromagnetic field to thereby cause the mechanical resonator to vibrate at one or more resonant vibration frequencies. An inductance coil, which has an inductance that varies with the one or more resonant vibration frequencies of the mechanical resonator, is disposed adjacent the mechanical resonator. A signal is modulated based on the inductance variation of the inductance coil, and the object. identification signal is generated based on the modulated signal.

Other independent features and advantages of the preferred object identification system and method will become apparent from the following detailed description, taken in conjunction with the accompanying drawings which illustrate, by way of example, the principles of the invention.

### BRIEF DESCRIPTION OF THE DRAWINGS

FIG. 1 is a functional block diagram of an embodiment of an object identification system according to the present invention;

FIG. 2 is an end view of an exemplary mechanical resonator that includes a plurality of tines and that may be used in the system of FIG. 1;

FIG. 3 is depicts a cantilever beam that is representative of one of the tines used to implement the mechanical resonator of FIG. 2;

FIG. 4 is a table depicting resonant vibration frequencies that correspond to a unique identification code of an exemplary mechanical resonator;

FIG. 5 is a functional block diagram of an embodiment of a sensor circuit that may be used to implement the system of FIG. 1;

FIG. 6 is a functional block diagram of an alternative embodiment of a sensor circuit that may be used to implement the system of FIG. 1; and

FIG. 7 is a functional block diagram of another alternative embodiment of a sensor circuit that may be used to implement the system of FIG. 1.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention.

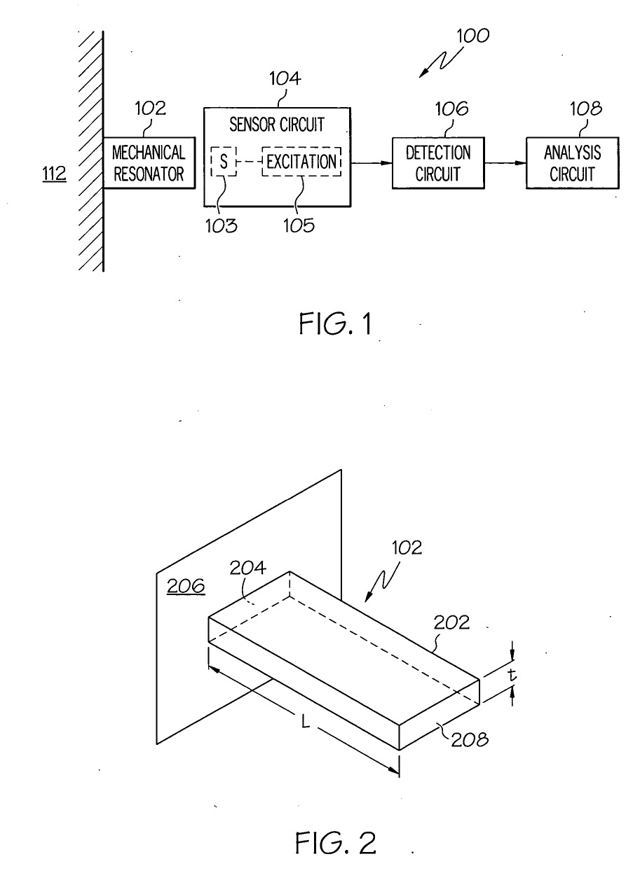

A functional block diagram of an exemplary object identification system 100 is illustrated in FIG. 1, and includes a mechanical resonator 102, a sensor circuit 104, a modulation detector circuit 106, and an analysis circuit 108. The mechanical resonator 102 is configured to be coupled to, or otherwise disposed adjacent to, a particular component 112 that is to be identified. The manner in which the mechanical resonator 102 is coupled to, or otherwise disposed adjacent to, the component 112 may vary and may depend, for example, on the type of material from which the component 112 is fabricated. For example, if the component 112 is constructed of a non-magnetic material such as, for example, a ceramic, the mechanical resonator 102, after being suitably encased, may be molded into the component 112 near the component surface. Alternatively, if the mechanical resonator 102 is constructed of a magnetic material, the mechanical resonator 102, after being suitably encased, may be welded to the component 112, or embedded into a shallow well in the component 112 and held in place by a suitable encapsulant. It will be appreciated that these are merely exemplary techniques and that the mechanical resonator 102 may be coupled to, or otherwise disposed adjacent to, the component 112 using any one of numerous techniques that are conventionally known.

The mechanical resonator 102 is configured to vibrate at one or more resonant vibration frequencies upon being excited with an electromagnetic field. The number of resonant vibration frequencies at which the mechanical resonator vibrates depends on its particular configuration. In particular, and with reference now to FIG. 2, the mechanical resonator 102 is implemented with one or more a cantilevered beams or tines 202. For clarity and ease of depiction and description, a single tine 202 is illustrated in FIG. 2 and, as depicted therein, is preferably configured as a rectangular beam having a first end 204 that is fixedly coupled to a main body 206, a second end 208 that is freely movable, a length (L), and a thickness (t). As is generally known, a cantilevered tine 202 has a resonant vibration frequency (fᵣₑₛ) that depends on the length (L) and thickness (t) of the tine 202, and the Young's modulus (Y) and density (ρ) of the material from which the tine 202 is manufactured. More specifically, the resonant vibration frequency (fᵣₑₛ) is given, to a close approximation, by:

$${f}_{res} = ( \frac{0.16 t}{{L}^{2}} ) {( \frac{Y}{ρ} )}^{0.5} .$$

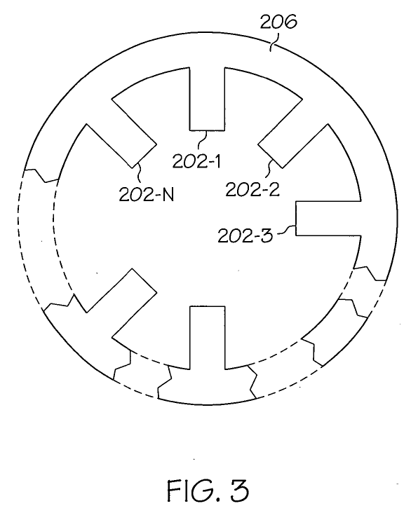

Thus, the resonant vibration frequency of the tine 202 can be controlled by appropriately selecting each of the variable parameters. It should be noted that tine width is not a frequency determining parameter. Moreover, the secondary resonant vibration frequency of the tine 202 is more than six times its primary resonant vibration frequency. As such, the mechanical resonator 102 is preferably implemented with a plurality of tines 202. An exemplary representation of one such implementation is shown in FIG. 3. In this implementation the mechanical resonator main body 206, only a portion of which is fully depicted in FIG. 3, is substantially circular in cross section, and a plurality of cantilevered tines 202 (202-1, 202-2, 202-3, . . . 202-N) are coupled to and extend radially inwardly from the main body 206.

No matter the specific configuration and implementation of the plurality of cantilevered tines 202, each tine 202 is configured to have a unique resonant vibration frequency that differs from the other tines 202. It will be appreciated that this may be accomplished using any one of numerous techniques. For example, if the tines 202 are all formed of the same material, then the resonant vibration frequency of each tine 202 can be adjusted by varying the individual tine lengths (L) and/or thicknesses (t) by, for example, laser cutting the tines 202. Conversely, each tine 202 could be formed of different materials, or selected ones of the tines 202 could be coated with a material that dampens its vibration, or shifts the resonant vibration frequency out of a particular frequency range. In a preferred embodiment each tine 202 is formed of the same, or a different, strongly magnetic material, and more preferably a ferromagnetic material. Moreover, in some embodiments, the tines 202 can be permanently magnetized. In each case, however, the material that is used is preferably able to withstand relatively high temperatures such as, for example, temperatures greater than about 200° C.

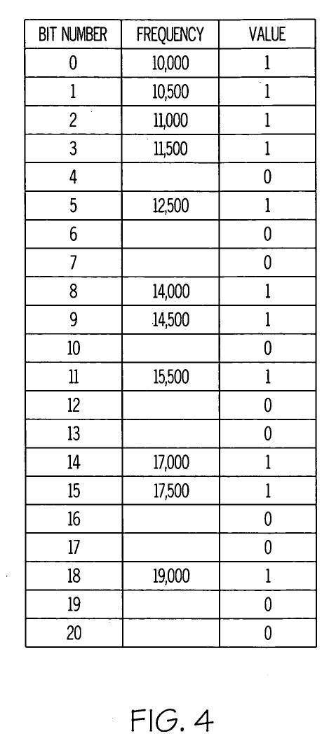

In view of the foregoing, it will be appreciated that the mechanical resonator 102 can be configured to have a unique identification code based on the unique resonant vibration frequencies of each tine 202, and through the presence and absence of tines 202 at given resonant vibration frequencies. For example, if the frequency of a first tine 202-1 is set at about 10,000 Hz, and subsequent tines 202-2, 202-3, 202-4, . . . 202-N are separated from each other by a 500 Hz frequency interval, a binary coded signal of N+1 bits in length can be generated in the frequency region of between about 10,000 Hz and (10,000+500N) Hz. This corresponds to 2^{N+1} unique identification codes. As an illustrative example, a table depicting the resonant vibration frequencies that correspond to the unique identification code of 314,159 (4CB2F hex) for a 21 bit scheme is depicted in FIG. 4.

It will be appreciated that the minimum frequency interval between the tines 202 may vary, but will principally depend on the Q of the mechanical resonator 102. For example, when a frequency interval of 500 Hz and a low-end frequency of 10,000 Hz are used, the Q should preferably be greater than about 20 to provide reasonable detection probability. It will additionally be appreciated that the Q of the mechanical resonator 102 will depend, for example, on the material properties and the machining precision that is used to manufacture the mechanical resonator 102.

Returning once again to FIG. 1, it is seen that the sensor circuit 104, depending on its particular configuration, is at least partially disposed adjacent to the mechanical resonator 102. The sensor circuit 104 is operable to supply the electromagnetic field that excites the mechanical resonator 102, causing the mechanical resonator 102 to vibrate at the one or resonant vibration frequencies. The sensor circuit 104 is additionally responsive to the vibration of the mechanical resonator 102 to supply a sensor signal that is modulated (e.g., either amplitude or frequency modulated) based on the one or more resonant vibration frequencies of the mechanical resonator 102.

To implement the above-described functions, the sensor circuit 104 preferably includes at least a sensor coil 103 and an excitation source 105. It will be appreciated that the particular configurations of the sensor coil and excitation source 105 may vary, depending on the particular technique that is utilized to both excite the mechanical resonator and detect its one or more resonant vibration frequencies. Preferably, an inductance sensing technique is used. Inductance sensing techniques generally include variable reluctance, mutual inductance, and eddy current sensing techniques. Any of these specific inductance sensing techniques may be used to implement, either partially or wholly, the sensor circuit 102. Thus, before proceeding further, each of these inductance sensing techniques, and the sensor circuits 102 that are implemented by each, will be described.

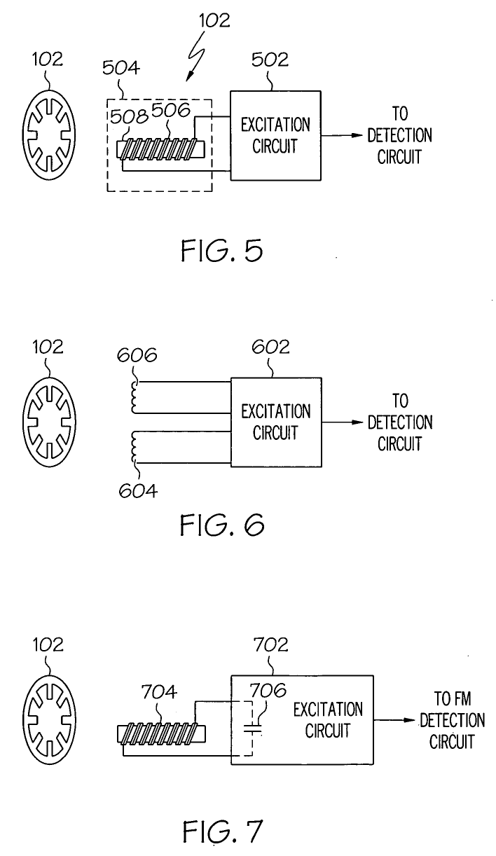

Turning first to FIG. 5, a sensor circuit 102 implemented using the variable reluctance technique is depicted and includes an excitation circuit 502 and a variable reluctance sensor 504. The excitation circuit 502 is configured to supply a continuous alternating current (AC) excitation signal or an excitation pulse to the variable reluctance sensor 504. The variable reluctance sensor 504 is disposed adjacent to the mechanical resonator 102 and includes a conductor coil 506 that is wrapped around a core 508 of magnetic material. Thus, upon receipt of the excitation pulse, the variable reluctance sensor 504 generates the electromagnetic field that excites the mechanical resonator 102. As is generally known, movement of a material adjacent to the coil 506, such as the vibration of the tines 202 in the mechanical resonator 102, changes the magnetic flux in the coil 506. As a result, an AC voltage is generated in the coil 506, which is amplitude modulated based on the one or more resonant vibration frequencies of the mechanical resonator 102.

A sensor circuit 102 that is implemented using the mutual inductance technique is depicted in FIG. 6, and includes an excitation circuit 602, an excitation coil 604, and a sensor coil 606. The excitation circuit 602 is configured to supply an AC excitation signal to the excitation coil 604, which is disposed adjacent to the mechanical resonator 102. In response to the excitation signal, the excitation coil 604 generates the electromagnetic field that excites the mechanical resonator 102. The excitation coil 604 is inductively coupled to the sensor coil 606 and thus an AC voltage is generated in the sensor coil 606. As with the variable reluctance sensor 504, vibration of the tines 202 in the mechanical resonator 102 changes the magnetic coupling between the excitation coil 604 and the sensor coil 606. As a result, the AC voltage that is generated in the sensor coil 606 is also amplitude modulated based on the one or more resonant vibration frequencies of the mechanical resonator 102.

With reference now to FIG. 7, a sensor circuit 102 implemented using the eddy current sensing technique is depicted and includes an oscillator circuit 702 and a sensor coil 704. The oscillator circuit 702 is coupled to the sensor coil 704 and, as will be described more fully below, supplies the frequency modulated sensor signal. The oscillator circuit 702 may be implemented using any one of numerous known types of oscillator circuits and oscillator circuit topologies, so long as it exhibits the appropriate circuit response characteristics. No matter the particular type or circuit topology, the oscillator circuit 702 includes a capacitive circuit element 706, which may be implemented as a single capacitor or multiple capacitors electrically coupled in parallel, series, or combination thereof to meet desired circuit characteristics. In any case, when the sensor coil 704 is coupled to the oscillator circuit 702, the capacitive circuit element 706 and sensor coil 704 are electrically coupled in parallel. Thus, the sensor coil 704 and the capacitive circuit element 306 form a parallel-resonant LC tank circuit, which determines the frequency of the oscillator circuit 702, and thus the instantaneous frequency of the supplied sensor signal.

More particularly, and as is generally known, the resonant frequency of a parallel-resonant LC tank circuit is:

$${f}_{res} = \frac{1}{2 π \sqrt{L C}}$$

where fᵣₑₛ is the resonant frequency (Hz), L is the inductance (H), and C is the capacitance (F). As is also generally known, when an inductance coil, such as the sensor coil 704, is in close proximity to a conductor, such as one or more of the tines 202 in the mechanical resonator 102, the conductor acts as a shorted coil turn that counteracts the inductance of the last coil turn. Thus, the sensor coil 704 will exhibit an inductance (L) that varies with the proximity of the tines 202 to the sensor coil 704. The proximity of each of the tines 202 to the sensor coil 704 will vary with the resonant vibration frequency of each tine 202. As a result, the frequency of the sensor signal supplied by the oscillator circuit 702 is frequency modulated based on the one or more resonant vibration frequencies of the mechanical resonator 102. It will be appreciated that the sensor coil 302 and capacitance element 314 may be constructed and/or selected to exhibit any one of numerous inductance and capacitance values, respectively, in order to cause the oscillator circuit 304 to oscillate within a desired frequency range.

Returning once again to FIG. 1, the remainder of the object identification system 100 will now be described. As was noted above, the sensor circuit 102, no matter its specific implementation, generates a sensor signal that is modulated at the tine 202 resonant frequency. The modulation detector circuit 106 is coupled to receive the frequency modulated sensor signal from the sensor circuit 102. In response, the modulation detector circuit 106 demodulates the modulated sensor signal, and supplies a demodulated sensor signal having one or more sensed frequencies that vary with, and are representative of, the one or more resonant vibration frequencies of the mechanical resonator 102. It will be appreciated that the modulation detector circuit 106 may be implemented, appropriate to the particular modulation type, as any one of numerous known amplitude or frequency demodulator circuits including, but not limited to, a slope detector, a Foster-Seeley detector, a quadrature detector, a phase-locked loop (PLL), and a digital signal processor (DSP).

No matter the specific implementation of the detector circuit 106, the analysis circuit 108 is coupled to receive the demodulated sensor signal. The demodulated sensor signal will, as alluded to above, be a mixture of the one or more sensed frequencies. The analysis circuit 108 is configured, upon receipt of the demodulated sensor signal, to determine each of the one or more sensed frequencies and, based on the determined frequencies, to supply an identification signal that is unique to the mechanical resonator 102. It will be appreciate that the analysis circuit 108 may be implemented using any one of numerous known circuits for determining individual frequency components of a signal. Such circuits include, but are not limited to, a digital signal processor, individual filter circuits, or any one of numerous frequency spectrum scanning circuits, such as a heterodyne detection circuit.

The object identification system and method described herein allows objects that are disposed in relatively high temperature environments to be reliably and remotely identified.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

I claim:

1. An object identification system, comprising:
a mechanical resonator configured to vibrate at one or more resonant vibration frequencies upon excitation thereof with an electromagnetic field; and
a sensor circuit including at least a portion thereof that is disposed adjacent the mechanical resonator, the sensor circuit operable to supply (i) the electromagnetic field to excite the mechanical resonator and (ii) a sensor signal that is modulated based on the one or more resonant vibration frequencies of the mechanical resonator.

2. The system of claim 1, further comprising:
a modulation detector circuit coupled to receive the modulated sensor signal and operable, in response thereto, to supply a demodulated sensor signal having one or more frequencies that vary with, and are representative of, the one or more resonant vibration frequencies of the mechanical resonator.

3. The system of claim 2, further comprising:
an analysis circuit coupled to receive the demodulated sensor signal and operable, in response thereto, to (i) determine each of the one or more frequencies and, based thereon, (ii) supply an identification signal that is unique to the mechanical resonator.

4. The system of claim 1, wherein the mechanical resonator comprises:
a main body; and
a plurality of cantilevered tines coupled to and extending from the main body, each of the cantilevered tines having a resonant vibration frequency that differs from the resonant vibration frequency of another cantilevered tine.

5. The system of claim 4, wherein one or more of the cantilevered tines is coated with a vibration dampening material.

6. The system of claim 4, wherein each of the cantilevered tines is substantially rectangular in shape and includes a top surface, a bottom surface, a first end that is fixedly coupled to the main body, and a second end, and has a predetermined length between the first and second ends and a predetermined thickness between the top and bottom surfaces.

7. The system of claim 6, wherein the predetermined length of each of the cantilevered beams differs from one another.

8. The system of claim 6, wherein:
the main body is substantially circular in cross section; and
each of the cantilevered tines extends radially inwardly from the main body.

9. The system of claim 8, wherein the plurality of cantilevered tines are evenly spaced from one another.

10. The system of claim 1, wherein the sensor circuit comprises:
a sensor coil disposed adjacent the mechanical resonator and having an inductance that varies with the resonant vibration frequency; and
an oscillator circuit coupled to the sensor coil and operable to supply the modulated sensor signal as a frequency modulated sensor signal.

11. The system of claim 1, wherein the sensor circuit comprises:
a variable reluctance sensor including a magnetic core and a sensor coil, the sensor coil wrapped at least partially around the magnetic core and operable to supply the modulated sensor signal in response to vibration of the mechanical resonator.

12. The system of claim 1, wherein the sensor circuit comprises:
a mutual inductance coil including an excitation coil and a sensor coil, the excitation coil coupled to receive an excitation signal and configured, in response thereto, generate a magnetic field that is disturbed in response to vibration of the cantilever beam, the sensor coil responsive to the disturbed magnetic field to supply the modulated sensor signal.

13. The system of claim 1, wherein the one or more resonant vibration frequencies differ by at least about 500 Hz.

14. An object identification system, comprising:
a mechanical resonator having a plurality of cantilevered tines coupled to and extending from a main body, each of the cantilevered tines configured to vibrate, upon excitation thereof with an electromagnetic field, at a resonant vibration frequency that differs from the resonant vibration frequency of another cantilevered tine; and
a sensor circuit including at least a portion thereof that is disposed adjacent the mechanical resonator, the sensor circuit operable to supply (i) the electromagnetic field to excite each of the cantilevered tines and (ii) a sensor signal that is modulated based on the resonant vibration frequencies of each of the cantilevered tines.

15. The system of claim 14, further comprising:
a modulation detector circuit coupled to receive the modulated sensor signal and operable, in response thereto, to supply a demodulated sensor signal having a plurality of sensed frequencies that vary with, and are representative of, the resonant vibration frequencies of each of the cantilevered tines.

16. The system of claim 15, further comprising:
an analysis circuit coupled to receive the demodulated sensor signal and operable, in response thereto, to (i) determine each of the sensed frequencies and, based thereon, (ii) supply an identification signal that is unique to the mechanical resonator.

17. A method of generating an object identification signal, comprising the steps of:
exciting a mechanical resonator with an electromagnetic field to thereby cause the mechanical resonator to vibrate at one or more resonant vibration frequencies;
disposing an inductance coil adjacent the mechanical resonator, the inductance coil having an inductance that varies with the one or more resonant vibration frequencies of the mechanical resonator;
modulating a signal based on the inductance variation of the inductance coil to thereby generate a modulated signal having a plurality of frequency components; and
generating the object identification signal based on the frequency components of the modulated signal.

18. The method of claim 16, further comprising:
demodulating the modulated signal, to thereby supply a sensor signal having the plurality of frequency components that vary with, and are representative of, the one or more resonant vibration frequencies of the mechanical resonator.

19. The method of claim 17, further comprising:
determining each of the plurality of frequency components; and
generating the object identification signal based on each of the plurality of determined frequency components.

20. The method of claim 16, wherein the one or more resonant vibration frequencies differ by at least about 500 Hz.
